(19) United States
(12) Patent Application Publication
(10) Pub. No.: US 2023/0053194 A1
(43) Pub. Date: Feb. 16, 2023

(54) METHOD FOR HIGH-SPEED COATING THE INNER SURFACE OF A BLANK

(71) Applicant: ESS Holding GmbH, Steyr (AT)

(72) Inventors: Alireza Eslamian, Steyr (AT); Martin Schifko, Steyr (AT)

(21) Appl. No.: 17/795,200

(22) PCT Filed: Jan. 4, 2021
(86) PCT No.: PCT/AT2021/060001

§ 371 Date: Jul. 25, 2022

(30) Foreign Application Priority Data
Jan. 29, 2020 (AT) A50066/2020

(51) Int. Cl. B05B 13/02; B05B 13/06; B05C 7/02; B05D 1/00; B05D 1/02; B05D 3/04; B05D 7/22; B05D 7/14; B65G 47/52

(52) U.S. Cl. CPC B05B 13/0242; B05B 13/0609; B05B 13/0228; B05B 13/0681; B05B 13/069; B05C 7/02; B05D 1/002; B05D 1/02; B05D 3/042; B05D 7/227; B05D 7/146; B65G 47/525

(57) ABSTRACT

In a method for the high-speed coating of the inner surface of a blank (1), preferably a can, the blank (1) rotates about it axis of rotation and a coating is applied to an inner surface of the blank (1). In order to allow for an increase in production rates and for a homogeneous coating of the inner surface of the blank (1), even with low coating thicknesses, without causing an increase in operating costs, a gas flow (10) is blown into the blank (1) via a nozzle (9) to accelerate the blank (1) and to distribute the coating in the direction of the axis of rotation (12).

### FIELD OF THE INVENTION

The invention relates to a method for high-speed coating the inner surface of a blank, preferably a can, wherein the blank rotates about its axis of rotation and a coating agent is applied to an inner surface of the blank. The invention further relates to a device for coating the inner surface of such a blank, comprising a loading station, a rotating device for rotating the blanks about their axis of rotation, an unloading station, and a carrier for conveying the blanks from the loading station to the unloading station.

### DESCRIPTION OF THE PRIOR ART

WO1994027735A1 describes a method for coating the inner or outer surfaces of cans. The cans are arranged in a carrier so that they can rotate about their axis of rotation and are guided past a coating nozzle with the aid of the carrier. For full-surface application of the coating agent to the inner surface of the cans, the cans are rotated about their axis of rotation while the coating agent is applied. GB1156530A shows a device for carrying out methods for coating the inner surfaces of cans, which are known from the prior art. The device has a carrier which is rotatable about a horizontal axis of rotation and comprises receptacles for cans likewise rotatable about a horizontal axis of rotation. The cans are stored in a loading station and move into the receptacles of the carrier as a result of their own weight. The cans are guided from the carrier to a nozzle, set in rotation and a coating agent is applied. The high speed of rotation is intended to achieve a uniform coating thickness of the coating agent. After coating, the can is conveyed to an unloading station, where it falls out of the receptacle of the carrier as a result of its own weight. A disadvantage of this is that very high rotational speeds of the cans in the range of 1800-2200 rpm are required to achieve a uniform coating thickness, which results in correspondingly high energy costs for large throughput rates. In addition, investigations of the cured can coating have shown that common methods produce voids or areas of excessive coating thickness, especially at low coating thicknesses in the range of a few micrometers. Another disadvantage is that unloading of the devices known from the prior art usually occurs by gravity-induced dropping of the blanks from the carrier, which is a limiting method step in terms of production speed.

### SUMMARY OF THE INVENTION

The invention is thus based on the object of proposing a method of the type described above, which allows homogeneous coating of the inner surface of the blank even at low coating thicknesses and, at the same time, an increase in production rates without causing an increase in operating costs.

The invention solves the given object by injecting a gas flow into the blank via a nozzle in order to accelerate the blank as well as to distribute the applied coating agent in the direction of the axis of rotation. As a result of this measure, the coating agent is applied to the inner surface of the blank not only in the circumferential direction as a consequence of the rotation of the blanks about their axis of rotation, but also in the direction of the axis of rotation due to the acceleration of the blank by the gas flow. In this context, application is understood as the uniform distribution of the coating agent onto the inner surface of the blank. The method according to the invention can be used particularly effectively with can blanks opened on one side.

This means that both the application of the coating agent and the injection of the gas flow, for example an air stream, are carried out on the opening side. This produces a coating film that is uniform over the entire inner surface of the blank. Moreover, due to the superposition of two accelerations, namely in the circumferential direction of the blank and in the direction of the axis of rotation of the blank, the inclusion of gas bubbles in the coating film is largely prevented because of the opposing forces. This is reinforced in particular by the gas flow generating a pressure wave which spreads over the coating agent, thereby ensuring a uniform coating thickness on the one hand and expelling any inclusions from the coating film on the other. Due to these mutually reinforcing phenomena, the rotational speed of the rotatably mounted blanks and therefore the energy input can be significantly reduced. The temperature of the gas flow can thereby be varied depending on the coating agent and used to accelerate the curing of the coating agent. The acceleration generated by the gas flow can also be used to eject the blanks from the receptacles of the carrier, thus increasing the cycle time of the method, which is limited in previously known methods due to the cans falling out of the receptacles of the carrier as a result of acceleration due to gravity.

In order to make the ejection of the blanks time- and energy-efficient without creating defects in the coating of the blank shell, it is proposed that the gas flow is directed against an attack surface of the blank that extends essentially transverse to the axis of rotation and adjoins the inner surface of the blank to be coated. Preferably, a surface is used as attack surface that is insensitive to defect formation during coating. In the case of cans, this attack surface can be the can bottom. This means that the majority of the impulse generated by the gas flow impinges on the insensitive attack surface. Starting from this point of impact, the pressure wave can spread evenly over the coated inner surface and ensure a homogeneous coating.

In order to ensure that the method can also be used for high throughput rates of blanks to be coated without having to accept losses in terms of coating quality, individual blanks can be conveyed from at least one loading station to at least one unloading station by means of a carrier having a plurality of blank receptacles, wherein the blanks are rotated about their axis of rotation between the loading station and the unloading station, and the at least partially coated blanks are ejected from the carrier in the unloading station with the aid of the gas flow. If the loading station, the nozzle for coating and for ejecting the blanks are arranged in a stationary manner, the method can be automated in a particularly simple manner and the equipment required for this can be maintained.

In order to be able to automate the method according to the invention to a large extent, it is advisable to carry it out with the aid of a device of the type mentioned at the beginning, wherein the unloading station comprises a nozzle directed in the direction of the axis of rotation of the blanks for ejecting the blanks. The nozzle can preferably be arranged in a stationary manner, wherein the carrier conveys the blanks past the nozzle. The direction of the gas flow generated by the nozzle does not necessarily have to be parallel or collinear to the axis of rotation of the blanks, but merely have a directional vector component that is parallel or collinear to the axis of rotation. Thus, an inflow at an angle to the axis of rotation is also conceivable. To enable simple loading and unloading of the blanks despite high production rates, it is proposed that the carrier is mounted rotatably about a vertical axis and has blank receptacles which are open radially outwards for loading in the direction of the vertical axis and for unloading in the direction of the axes of rotation. The blanks rotatably mounted in the blank receptacles can thus be conveyed by the rotatably mounted carrier from the loading station to the unloading station in a structurally simple manner. Through the openings in the blank receptacles according to the invention, loading can be carried out with the aid of loading stations known from the prior art, and unloading can be carried out with the aid of the nozzle according to the invention. Advantageously, the vertical axis can intersect with the rotational axes of the blanks arranged in the blank receptacles at a common center point. This results in a particularly easy-to-handle process. First, the blanks are stored in a loading station, from where they are transferred by gravity to the blank receptacles of the carrier without any further energy being supplied. The carrier conveys the blanks to a first nozzle, which applies a coating agent to the inner surface of the blank. During or after the application of a coating agent, the blank is rotated for uniform application of the coating agent. Subsequently, the blank is conveyed to the unloading station, where it is accelerated out of the carrier by a gas flow from a nozzle associated with the unloading station. The unloading station can have a collecting container for the blanks for this purpose.

Different operating means can be provided for coating different blanks. In order to enable both simple supply of these operating means and rapid replacement of these operating means, the carrier can form a ring with blank receptacles extending radially outward. As a result of this measure, the lines for conveying the operating means can be arranged in the center of the ring and therefore stationary. Since the nozzle for generating the gas flow can also be arranged in the center, both the coating agent and the gas flow can be introduced into the blank via the same opening of the carrier. To allow loading and unloading of the carrier at multiple locations on the carrier, it is proposed that the vertical axis be oriented vertically and normal to the axes of rotation of the blanks. As a result, a plurality of loading stations known in the prior art which load the carrier with the blanks as a result of gravity can also be used at arbitrary locations on the carrier, thereby significantly speeding up the loading of the carrier. In addition, several unloading stations according to the invention can also be used, wherein the horizontal orientation of the rotation axes of the blanks enables both energy-efficient ejection of the blank by the gas flow, and uniform distribution of the coating agent on the inner surface of the blank. The required alignment of the axes of rotation of the blanks also has the advantage that, as the blanks are conveyed by the carrier, which is mounted so that it can rotate about its vertical axis, the coating agent is already distributed outward in the direction of the axis of rotation as a result of centrifugal force.

In order not only to increase the loading rate, but also to accelerate the entire method for high-speed coating the inner surface of a blank, it is recommended in a particularly advantageous embodiment of the invention that the carrier be provided for at least two processing segments, each having a loading station and an unloading station. Each processing segment has all the necessary means for coating the blanks. Only the conveying of the blanks between the required means is carried out by the common carrier. With a correspondingly large design of the carrier, a large number of processing segments operating independently of one another can be provided. This allows the production rate to be increased without having to increase the speed of rotation of the carrier.

### BRIEF DESCRIPTION OF THE INVENTION

In the drawing, the subject matter of the invention is shown by way of example, wherein:

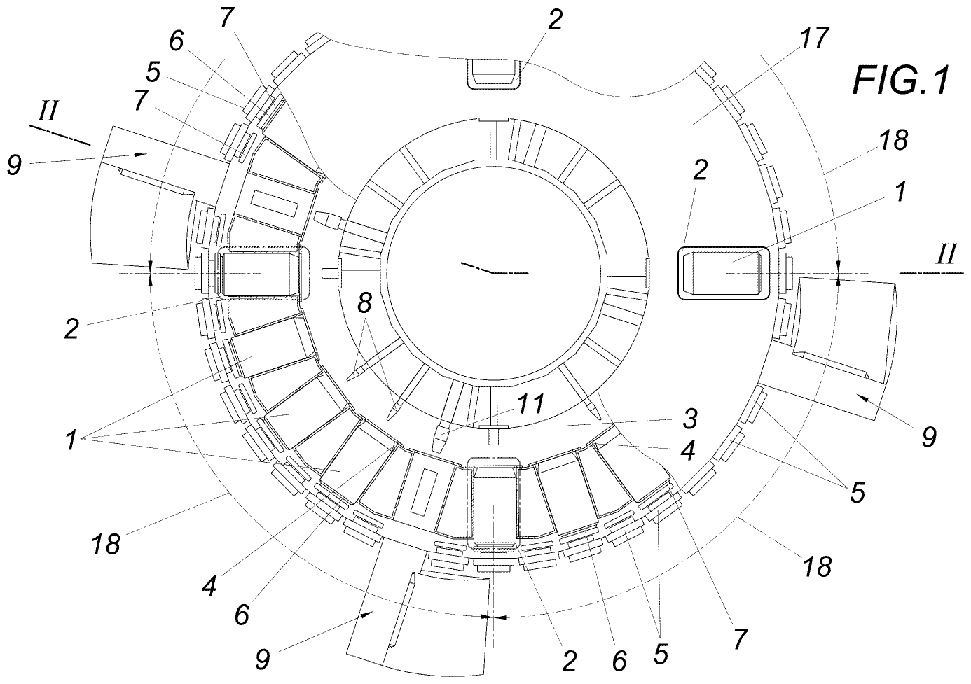

FIG. 1 shows a top view of the device according to the invention and

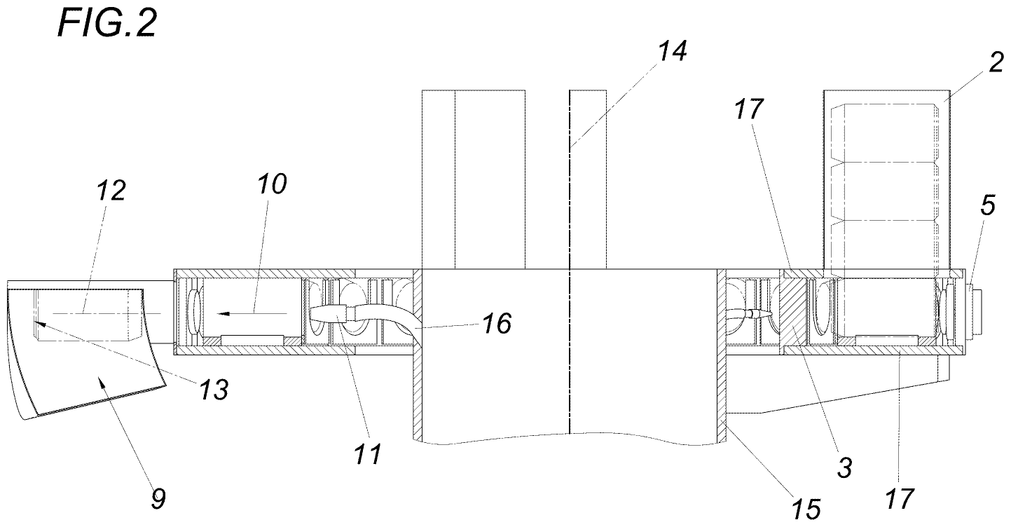

FIG. 2 shows a section along line II-II of FIG. 1.

### DETAILED DESCRIPTION OF THE PREFERRED EMBODIMENTS

A device according to the invention for coating the inner surface of a blank 1, preferably a can, comprises, as can be seen for example in FIG. 1, a loading station 2 for loading a carrier 3 with the blanks 1. The blanks 1 are rotatably mounted in blank receptacles 4 of the carrier 3. The rotation of the blanks 1 can be performed by rotation devices 5, which can accelerate the blanks 1 via a frictional connection with the blank bottom 6. The rotation device 5 can, for example, be an electric motor with a plate 7 cooperating frictionally with the blank bottom 6. The blanks 1 are conveyed by the carrier 3 from the loading station 2 to nozzles for coating 8 the inner surface of the blank 1. There, a coating agent is applied to the inner surface of the blanks 1, after which or while the blanks 1 are accelerated in the circumferential direction by the rotating devices 5. This results in an initial application, i.e. a distribution of the coating agent along the inner surface of the blanks 1. The application of the coating agent can take place via several nozzles 8. The carrier 3 then conveys the blanks 1 to the unloading station 9, where a gas flow 10 (FIG. 2) is blown into the blank 1 via a nozzle 11, thereby accelerating the blank 1 in the direction of its axis of rotation 12 and ejecting it from the carrier 3. In this way, a particularly uniform application of the coating agent to the inner surface is achieved, since the distribution takes place not only circumferentially by rotation of the blank 1, but also by acceleration along the axis of rotation 12.

Particularly efficient acceleration of the blank 1 can be achieved if, as can be seen in particular from FIG. 2, the gas flow 10 is directed against an attack surface 13 extending essentially transversely to the axis of rotation 12.

As shown in FIG. 2, the carrier 3 can be rotatably mounted about a vertical axis 14. To enable gravity-driven loading of the carrier 3 by the loading stations 2 and ejection of the blanks 1 from the carrier 3 induced by the gas flow 10 of the nozzle 11, it is advisable for the carrier 3 to have blank receptacles 4 which are open at the top in the direction of the vertical axis 14 and radially outward in the direction of the axes of rotation 12. Favorable design conditions are obtained when the axes of rotation 12 intersect the vertical axis 14 at a common point.

It can be seen from FIG. 1 that the carrier 3 can be designed as a ring, which has radially outwardly extending blank receptacles 4. The ring-shaped carrier 3 can be rotatably mounted on the stator 15. The nozzles 8, 11 can be arranged on the stator 15, whereby a supply of operating means to the nozzles 8, 11 can be effected via stationary lines 16. In order to prevent the entry of any dirt particles during the coating process, the carrier 3 can be arranged between two stationary shielding surfaces 17, which form receptacles for rotary devices 5. The loading station 2 can be provided on the cover-side shielding surface 17.

A particularly energy-saving loading and unloading of the blanks 1 can take place if, as is disclosed in FIG. 2, the vertical axis 14 of the carrier 3 is aligned vertically and is normal to the axes of rotation 12 of the blanks 1. This also results in the advantage that a centrifugal force-induced distribution of the coating agent outwardly in the direction of the axis of rotation 12 of the blanks 1 is achieved solely by the conveying process of the blanks 1 in the carrier 3.

From FIG. 1, which corresponds to a top view of the device according to the invention, it can be seen that the carrier 3 can be provided for several working segments 18. In this way, the production rate can be increased without having to increase the rotation speed of the carrier 3. A loading station 2, nozzles 8, 11 and an unloading station 9 are assigned to each working segment 18.

Please amend the claims and add new claims as follows:

1. A method for high-speed coating an inner surface of a blank said method comprising:
rotating the blank about an axis of rotation thereof; and
applying a coating agent to the inner surface of the blank; and
blowing a gas flow into the blank via a nozzle so as to accelerate the blank and so as to distribute the coating agent in the direction of the axis of rotation.

2. The method according to claim 1, wherein the gas flow is directed against an attack surface of the blank, said attack surface extending substantially transversely to the axis of rotation and adjoining the inner surface of the blank that is coated.

3. The method according to claim 1, wherein individual blanks are conveyed by the carrier in a plurality of blank receptacles from at least one loading station to at least one unloading station, and wherein the blanks are each rotated about their an axis of rotation thereof between the loading station and the unloading station, and the blanks, when at least partially coated, are ejected from the carrier in the unloading station with aid of the gas flow.

4. A device for coating inner surfaces of blanks, said device comprising:
a loading station;
a rotating device rotating the blanks about an axis of rotation;
an unloading station; and
a carrier for conveying the blanks from the loading station to the unloading station;
wherein the unloading station has a nozzle being directed in a direction of the axis of rotation and ejecting the blanks.

5. The device according to claim 4, wherein
the carrier is mounted rotatably about a vertical axis and has blank receptacles open radially outwardly so as to provide loading of the blanks in a direction of the vertical axis and unloading of the blanks in the direction of the axes of rotation.

6. The device according to claim 5, wherein
the carrier forms a ring with radially outwardly extending blank receptacles.

7. The device according to claim 5, wherein the vertical axis is vertically aligned and normal to the axes of rotation of the blanks.

8. The device according to claim 4,
wherein the carrier is associated with at least two processing segments, each having a respective loading station and a respective unloading station.

9. The device according to claim 6, wherein the vertical axis is vertically aligned and normal to the axes of rotation of the blanks.

10. The device according to claim 5, wherein the carrier is associated with at least two processing segments, each having a respective loading station and a respective unloading station.

11. The device according to claim 6, wherein the carrier is associated with at least two processing segments, each having a respective loading station and a respective unloading station.

12. The device according to claim 7, wherein the carrier is associated with at least two processing segments, each having a respective loading station and a respective unloading station.

13. The device according to claim 9, wherein the carrier is associated with at least two processing segments, each having a respective loading station and a respective unloading station.

14. The method according to claim 2, wherein individual blanks are conveyed by the carrier in a plurality of blank receptacles from at least one loading station to at least one unloading station, and wherein the blanks are each rotated about an axis of rotation thereof between the loading station and the unloading station, and the blanks, when at least partially coated, are ejected from the carrier in the unloading station with aid of the gas flow.
